(19) United States
(12) Patent Application Publication
(10) Pub. No.: US 2008/0259759 A1
(43) Pub. Date: Oct. 23, 2008

(54) Optical Disc Having Combined Rom/R Area

(75) Inventors: Hubert Cecile Francois Martens, Eindhoven (NL); Ruud Vlutters, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,565

(22) PCT Filed: Jan. 28, 2005
(86) PCT No.: PCT/IB05/00249

§ 371 Date: Jul. 31, 2006

(30) Foreign Application Priority Data
Feb. 3, 2004 (EP) 04100389.8

(51) Int. Cl. G11B 3/74; G11B 7/00

(52) U.S. Cl. 369/94; 369/100

(57) ABSTRACT

A record carrier has information represented by high density read-only marks in a track. The read-only marks (74,75) are optically readable according to a predefined high-density data format such as CD or DVD via a beam of radiation by first variations of the radiation. The record carrier has a recordable layer (70) for writing recorded marks (72,73) in a recording area of the record carrier, which recording area extends over the track (9) carrying the read-only marks. The recordable layer (70) is arranged to generate second variations of the radiation by a difference between an unrecorded state and a recorded state. A recording device writes recorded marks on top of the read-only marks. A read device recovers the first and second variations, and detects the read-only marks and the recorded marks from a same part of the track.

The invention relates to a record carrier carrying information represented by read-only marks in a track, the read-only marks being optically readable according to a predefined high-density data format via a beam of radiation by first variations of the radiation, the record carrier comprising a recordable layer for writing recorded marks in a recording area of the record carrier.

The invention further relates to a device for recording the record carrier, a device for reading the record carrier and a method for recording information on the record carrier.

An optical record carrier is known from US2003/0007448. The record carrier has a read-only (ROM) area from which only reproduction is made, and a recordable (RAM) area on which information can be recorded. Such a record carrier may be called a combi-disc or a hybrid disc because read-only data and recorded data are both accommodated on the record carrier. In the ROM area data is represented by pits which can be read according to an existing, high data capacity data storage format like CD or DVD. Hence the pits are read-only marks optically readable according to a predefined high-density data format via a beam of radiation by variations of the radiation that is reflected from the track. In the RAM area a preformed track pattern is provided, e.g. a modulated pregroove. A radiation sensitive recordable layer is provided for forming the marks in the RAM area. A recording device has auxiliary detectors for generating tracking servo signals based on the preformed track pattern for detecting a spatial deviation of a head with respect to the track. The tracking servo signals are used to control actuators to position the head on the track, and data is recorded in recorded marks according to a data recording format. The recorded marks are also detected during reading by variations of the reflected radiation. The recordable layer is applied on the record carrier during manufacture, e.g. using a spin-coating process. Hence the recording material will also be present in the ROM area, but is made to have a higher thickness and/or absorption in the RAM area, in order not to significantly disturb reading of the pits in the ROM area.

A problem of the known combi-disc is that the pits in the ROM area and the preformed track pattern in the RAM-area, which are both shaped in a substrate material, require different depths or heights of the substrate material. In addition the layer of recordable material needs to be different between the ROM area and the RAM area. Hence manufacture of the combi-disc is complex.

Therefore it is an object of the invention to provide a record carrier which has less complex manufacturing requirements for the track carrying the read-only marks and the recording area, and a corresponding recording device and reading device.

According to a first aspect of the invention the object is achieved with a record carrier as defined in the opening paragraph, wherein the recording area extends over the track carrying the read-only marks, and which recordable layer is arranged to generate second variations of the radiation by a difference between an unrecorded state and a recorded state, the first and second variations being different for allowing detection of the read-only marks and the recorded marks from a same part of the track.

According to a second aspect of the invention the object is achieved with a device for recording information on the record carrier according to the invention, the device comprising a head for providing the beam, and recording means for, while scanning the track containing the read-only marks, controlling an intensity of the beam for writing the recorded marks by modifying the recordable layer from the unrecorded state to the recorded state.

According to a third aspect of the invention the object is achieved with a device for reading information from the record carrier according to the invention, the device comprising a head for providing the beam and generating a reading signal, and reading means for, while scanning the track containing the read-only marks, detecting the second variations for reading the recorded marks.

According to a fourth aspect of the invention the object is achieved with a method of recording information on the record carrier according to the invention, the method comprising scanning the track containing the read-only marks via a beam of radiation, and, while scanning the track, controlling an intensity of the beam for writing the recorded marks by modifying the recordable layer from the unrecorded state to the recorded state.

The effect of the measures is that the recorded marks are superimposed on the track already provided with read-only marks. Read-only marks and recorded marks are retrievable from the same part of the track. For reading the recorded marks the reading device is provided with detection circuitry, e.g. based on low pass filters, for retrieving data from the recorded marks. Hence on the record carrier no separate area is required for recording data, and no separate preformed track pattern is required. Advantageously the same manufacturing requirements are applicable for the total data storage area of the record carrier. In addition this has the advantage that an additional data storage capacity for recording is created, while the read-only data capacity of the record carrier is substantially unchanged compared to a record carrier only carrying read-only marks.

The invention is also based on the following recognition. The read-only marks which are commonly used, e.g. on CD or DVD, have a high data density and provide ample reading signal and tracking signals for a read head to scan the track and detect the read-only marks. The inventors have seen that a low density recorded signal, e.g. based on low contrast recorded marks, will not significantly degrade the reading signal of the read-only marks. In addition, the read-only marks provide tracking signals which can be used as tracking signals for positioning the recording head on the track of read-only marks during writing the recorded marks.

In an embodiment of the record carrier the first variations and second variations are variations of intensity of reflected radiation, the second variations being substantially smaller than the first variations. This has the advantage that a front end detector circuit in a scanning device may be shared for generating reading signals for detecting both variations, while the second variations only marginally degrade the reading signal of the read-only marks.

In an embodiment of the record carrier the recorded marks are substantially longer than the read-only marks, in particular an average length the recorded marks being at least ten times an average length of the read-only marks. This has the advantage that a high frequency reading signal for retrieving read-only data and a low frequency reading signal for retrieving recorded data are generated, which are easily separatable.

In an embodiment of the record the recordable layer is a refractive layer having at least two distinct refractive index levels for generating the second variations, in particular the refractive layer substantially filling pits that constitute the read-only marks. This has the effect that recorded parts of the track have a different effect on the radiation, resulting in a phase difference between unrecorded pits and recorded pits. Due to the phase differences the radiation will be modulated differently, which can be easily detected.

In an embodiment the recording device comprises reading means for detecting the read-only marks, and the recording means are arranged for controlling said intensity in dependence of the read-only marks. This has the advantage that the recorded mark is formed taking into account the read-only marks, e.g. for reducing the degrading of the reading signal of the read-only marks.

In an embodiment of the reading device the reading means comprise separation means for simultaneously generating, from the reading signal, a high frequency reading signal for reading the read-only marks and a low frequency reading signal, and detector means for detecting the second variations from the low frequency reading signal for reading the recorded marks. This has the advantage that the data represented by the recorded marks is available at the same time as the read-only data.

Further preferred embodiments of the record carrier and device according to the invention are given in the further claims.

These and other aspects of the invention will be apparent from and elucidated further with reference to the embodiments described by way of example in the following description and with reference to the accompanying drawings, in which

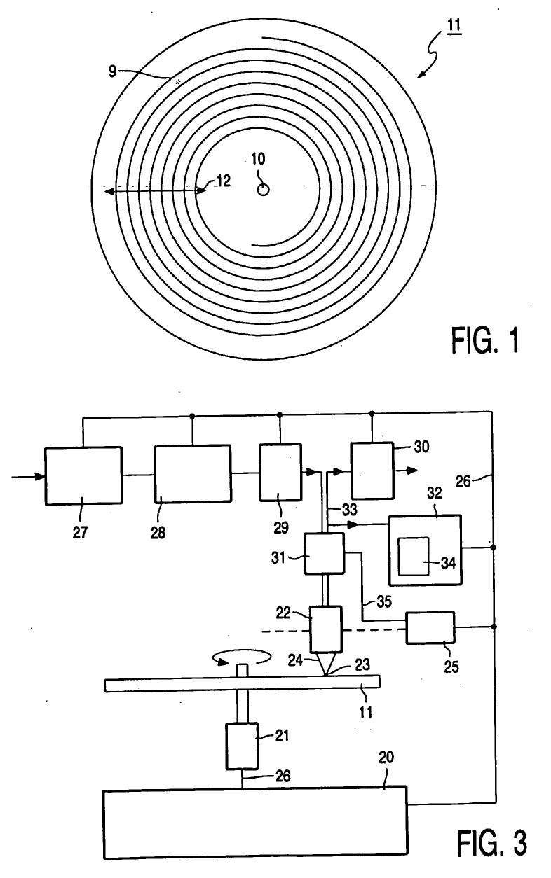

FIG. 1 shows a disc-shaped record carrier (top view),

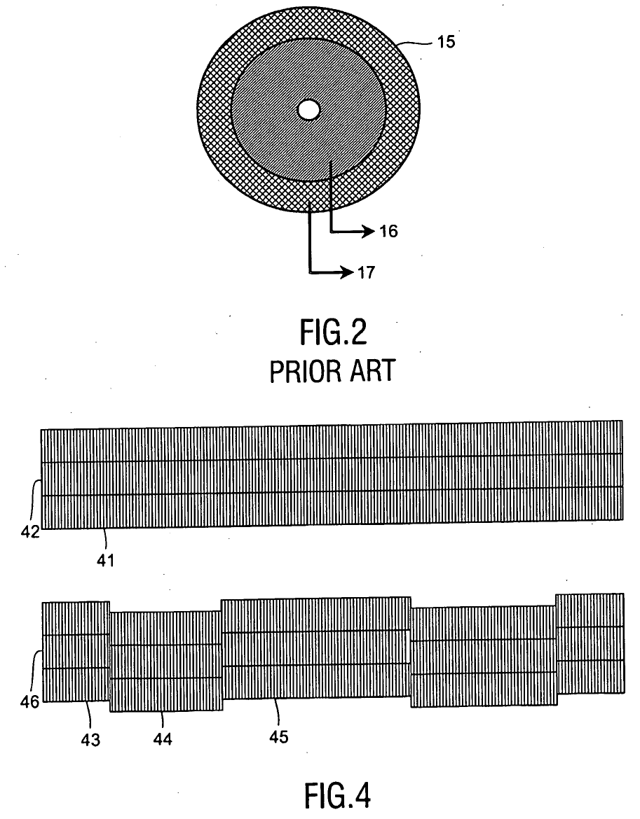

FIG. 2 shows a prior art ROM-R combi disc,

FIG. 3 shows a scanning device having secondary data channel for recorded marks,

FIG. 4 shows schematically an eye-pattern for ROM data and for a combination of recorded data and ROM data,

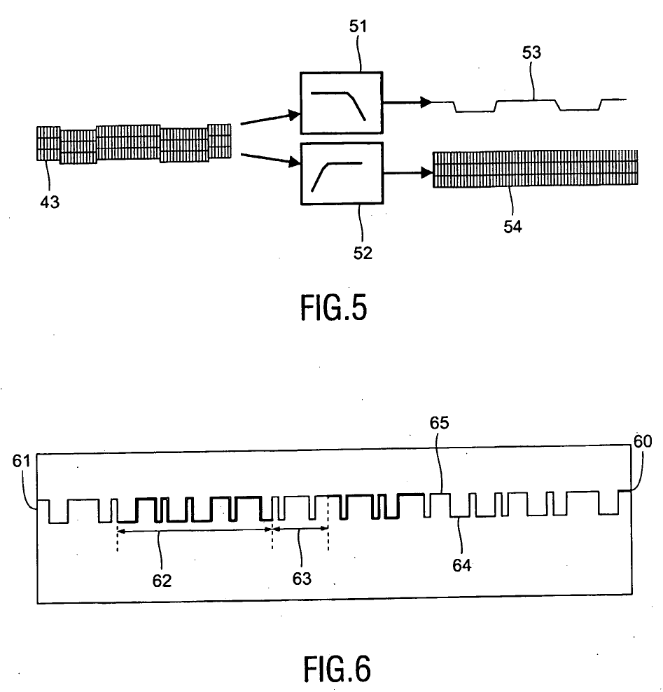

FIG. 5 shows a schematic layout of separation of LF and HF channel bit streams,

FIG. 6 shows a recorded part of a track having a recordable mirror,

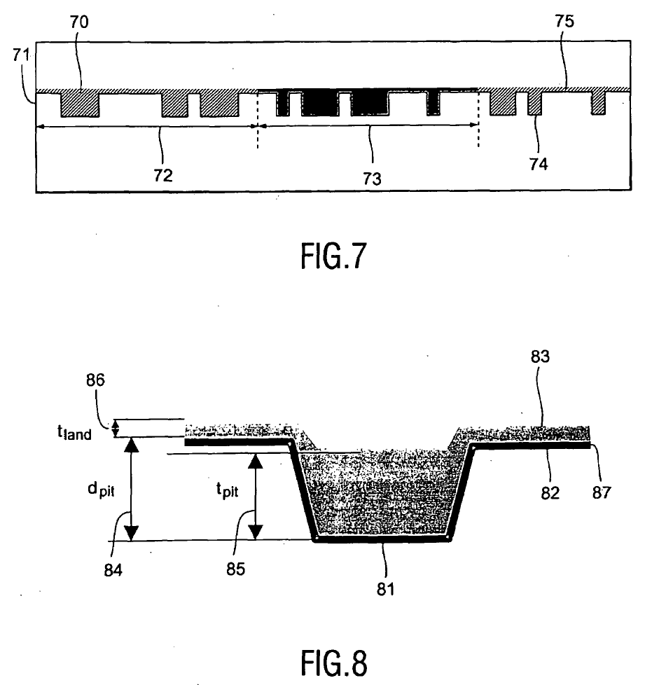

FIG. 7 shows a part of a track having recorded marks by phase differences, and

FIG. 8 shows a cross-section of a pit and land sequence filled with dye.

In the Figures, elements which correspond to elements already described have the same reference numerals.

FIG. 1 shows a disc-shaped record carrier 11 having a track 9 and a central hole 10. The track 9 is arranged in accordance with a spiral pattern of turns constituting substantially parallel tracks on an information layer. The track is constituted by marks of a read-only type, which represent information according to a predefined format. Such record carriers are commonly called ROM discs (Read Only Memory). The marks are constituted by variations of a first physical parameter and thereby have different optical properties than their surroundings, e.g. variations in depth forming pits and lands in a substrate layer. The marks are detectable by variations in the reflected beam, e.g. variations in reflection. Such record carriers are well-known, for example the CD (Compact Disc) or DVD (Digital Versatile Disc).

The track enables an optical head to follow the track 9 during scanning. The record carrier may be carrying real-time information, for example video or audio information, or other information, such as computer data. Content distribution on optical ROM discs is very successful because of the low costs and ease of media replication. A problem, however, for ROM media is that the content on the media is fixed (indicated by the name ROM). It would be advantageous if additional (user-specific) data could be added to the fixed ROM data. An example of additional data is that content owners may want to provide (sell) specific keys that can be stored physically on the ROM disc and that would allow certain features of the content on the ROM disc to be enabled or disabled. Further exampled include updating the content on the disc, e.g. for games: keeping track of high-scores, adding new levels, features, etc, or in general adding software updates, patches, etc.

FIG. 2 shows a prior art ROM-R combi disc. A disc shaped record carrier 15 has a first annular zone, which is a ROM area 16 assigned to read-only content, and a second annular zone constituted as a recordable area 17. The ROM zone contains read only marks, for example pits and lands, whereas the recordable zone 17 is manufactured like a recordable disc. Examples of a recordable disc are the CD-R and CD-RW, and the DVD+RW. The track on the recordable area of the record carrier is indicated by a pre-embossed track structure provided during manufacture of the blank record carrier, for example a pregroove. Recorded information is represented in a radiation sensitive recording layer by optically detectable marks written along the track. Disadvantages of the existing combi disc are that the manufacture of the record carrier is complicated. In general pre-grooves and pits must be mastered at different depths, and this is a difficult, hence expensive, process. In addition ROM data capacity is lost, as the second annular area must be sacrificed to be recordable at the expense of ROM data capacity.

According to the invention a record carrier 11 as shown in FIG. 1 is carrying information represented by read-only marks in the track 9, which read-only marks are optically readable according to a predefined high-density data format via a beam of radiation by first variations of the radiation. In addition the record carrier 11 has a recordable layer for writing recorded marks in a recording area of the record carrier, which recording area extends over an annular area indicated by arrow 12 corresponding to the area covered by the track carrying the read-only marks. The recordable layer is arranged to generate second variations of the radiation by a difference between an unrecorded state and a recorded state. Hence the recorded marks are recorded superimposed on the read-only marks. The first and second variations are different for allowing detection of the read-only marks and the recorded marks from a same part of the track. Hence recordable data, so-called R-data, are represented by the recorded marks in the recordable layer, while read-only (ROM) data is represented by the preformed read-only marks on the same part of the track.

In an embodiment of the recordable layer, the contrast between recorded and unrecorded areas is limited in order not to deteriorate the ROM data. A practical solution is to limit the contrast of the recordable layer in the ROM area to values smaller than the amplitude of a HF (ROM) read signal, in particular of the highest frequency in the HF-signal (caused by the shortest marks usually measured in channel bit lengths T, e.g. 3T in DVD and 2T in BD).

In the proposed solution the R functionality is located in the same area as the ROM data-storage. Then the ROM data can be “overwritten” with the additional data. In an embodiment this is achieved by using a (low-contrast) recordable mirror instead of the conventional metallic mirror, described below with reference to FIG. 6.

In many practical circumstances a required R-capacity is significantly smaller than the required ROM capacity. In an embodiment the bit-length of the R-data is significantly different (longer, e.g. 10× longer) than the ROM-data bit-length, as elucidated with reference to FIGS. 4 and 5. This has also the advantage that after the recording the ROM data can still be easily read. The additional information may be used as control information that is processed in the scanning apparatus or a host computer, e.g. a code for accessing recorded information, an identifier to support copy-control, anti-piracy information and other accessing mechanisms.

FIG. 3 shows a scanning device having secondary data channel for recorded marks. The device is provided with means for scanning a track on a record carrier 11 which means include a drive unit 21 for rotating the record carrier 11, a head 22, a servo unit 25 for positioning the head 22 on the track, and a control unit 20. The head 22 comprises an optical system of a known type for generating a radiation beam 24 guided through optical elements focused to a radiation spot 23 on a track of the information layer of the record carrier. The radiation beam 24 is generated by a radiation source, e.g. a laser diode. The head further comprises (not shown) a focusing actuator for moving the focus of the radiation beam 24 along the optical axis of said beam and a tracking actuator for fine positioning of the spot 23 in a radial direction on the center of the track. The tracking actuator may comprise coils for radially moving an optical element or may alternatively be arranged for changing the angle of a reflecting element. The focusing and tracking actuators are driven by actuator signals from the servo unit 25. For reading the radiation reflected by the information layer is detected by a detector of a usual type, e.g. a four-quadrant diode, in the head 22 for generating detector signals coupled to a front-end unit 31 for generating various scanning signals, including a main scanning signal 33 and error signals 35 for tracking and focusing. The error signals 35 are coupled to the servo unit 25 for controlling said tracking and focusing actuators. The main scanning signal 33 is processed by read processing unit 30 of a usual type including a demodulator, deformatter and output unit to retrieve the information from the read-only marks.

The control unit 20 controls the scanning and retrieving of information and may be arranged for receiving commands from a user or from a host computer. The control unit 20 is connected via control lines 26, e.g. a system bus, to the other units in the device. The control unit 20 comprises control circuitry, for example a microprocessor, a program memory and interfaces for performing the procedures and functions as described below. The control unit 20 may also be implemented as a state machine in logic circuits.

For reading the additional recorded information the device is provided with a secondary demodulation unit 32 for detecting the second variations in the scanning signal due to the recorded marks. The main scanning signal 33 is received from the front-end unit 31, which front-end unit is shared for the read-only data and the recorded data. Components in the signal 33 due to the read-only marks of the main information are removed and components due to the recorded marks are isolated, e.g. by filtering. The additional information is retrieved from remaining reading signal by the secondary demodulation unit 32. For example the demodulation unit 32 may have a shift detection circuit for detecting in the reading signal a shift in amplitude and/or level for detecting the second variations for reading the recorded marks.

Timing recovery for reconstructing a data clock of the recorded marks can be based on the frequency of the secondary marks. In an embodiment timing recovery is based on the data clock retrieved from the read-only data. Synchronous detection can be applied for detecting the data bits of the recorded data. In an embodiment the recorded data is encoded with a channel code and/or error correction codes different from the channel codes used in the read-only data, and the demodulation unit 32 is provided with a dedicated channel code demodulator and/or error correction unit.

In an embodiment the demodulation unit 32 has a separation unit 34 that has a low pass or band pass filter function specifically tuned to the recorded marks being substantially longer than the read-only marks, as explained with FIG. 5. A detector circuit is provided for, after separating the second variations, detecting the recorded data.

In an embodiment the modulation unit 32 is arranged to detect recorded marks only in predefined parts of the track in dependence of the read-only marks, e.g. detecting the second variations in the reading signal only on top of pits. The recorded parts may be only applied to read-only marks of a predefined range of lengths, e.g. only on top of read-only marks having a length of 7T or longer.

In an embodiment the device is provided with a more complicated detection scheme for retrieving the read-only data by using a correction procedure of the HF ROM-data by using knowledge from the detected R-data. For example a detection threshold for the HF signal is shifted to separate levels for recorded and unrecorded parts of the track. It is noted that detecting the R data from low contrast of the recorded marks is not problematic because of the reduced bandwidth of the R data channel allowing for filtering, e.g. using integration times substantially longer than the read-only marks. A long bit length (low bit rate) for the R-functionality further has the advantage in power consumption because no fast driver electronics are required, e.g. advantageous for portable applications.

In an embodiment the device is a recording device provided with recording means for recording information on the recordable layer of the record carrier according to the invention. The recording means include the head 22 being a recording head and cooperate with front-end unit 31 for generating a controllable beam of radiation, and comprise write processing means for processing the input information to generate a write signal to drive the head 22, which write processing means comprise an input unit 27, a formatter 28 and a modulator 29. For writing information the beam of radiation is controlled to create optically detectable marks in the recording layer. The marks may be in the form of areas with a reflection coefficient different from their surroundings, obtained when recording in materials such as dye, alloy or phase change material, or in the form of areas with a direction of polarization different from their surroundings, obtained when recording in magneto-optical material. Further examples are described with FIGS. 6, 7 and 8.

In an embodiment the recording device is provided with a synchronization circuit, e.g. a phase locked loop (PLL) included in the modulator 29. During recording the read-only marks from the track are detected, and a timing signal is recovered and coupled to the synchronization circuit. The synchronization circuit controls the timing of the writing of recorded marks, in order to achieve a predefined timing relationship between the recorded marks and the read-only marks. For example, the signal transitions between unrecorded and recorded parts of the recorded marks may be aligned with the channel bit distance, or may be aligned with transitions between lands and pits, pits and lands or both. In addition the recorded marks may be positioned in the track based on headers and/or synchronization marks in the read-only data.

It is noted that the recording device may also be arranged to record data on the well-known recordable discs such as CVD-R, DVD+RW or BD (Blu-ray Disc). The recording means described above may be arranged to alternatively perform such recording on the standard recordable discs. Furthermore, writing and reading of information for recording on optical disks and formatting, error correcting and channel coding rules are well-known in the art, e.g. from the CD or DVD system. In an embodiment the input unit 27 comprises compression means for input signals such as analog audio and/or video, or digital uncompressed audio/video. Suitable compression means are described for video in the MPEG standards, MPEG-1 is defined in ISO/IEC 11172 and MPEG-2 is defined in ISO/IEC 13818. The input signal may alternatively be already encoded according to such standards.

FIG. 4 shows schematically an eye-pattern for ROM data and for a combination of recorded data and ROM data. In the schematic example a top graph 41 shows an eye-pattern for a bare ROM disc (having no recorded marks), and a center part 42 shows the eye of possible detection levels for detecting the data from the reading signal. A lower graph 43 shows an eye-pattern of ROM data overwritten with low-contrast low-density data. A recorded part 44 has a lower reading signal level than an unrecorded part 45 (or vice versa). A center part 46 indicates that the reading signal still can be used to apply detection levels for detecting the HF ROM data. The small low-frequency modulation on top of the HF data does not significantly deteriorate the HF bit-detection. It is noted that the LF modulation can be separated e.g. via filtering. FIG. 4 presents a schematic example of the present idea. The bare disc contains normal ROM HF-data having relatively small channel bit length (comparable to optical spot 23). On top of the HF reading signal a LF signal is superimposed. In the example the LF signal has modulation amplitude that is <20% of the HF modulation amplitude in order not to deteriorate the HF bit detection. Further the channel bit length of the LF modulation is at least 10 times longer than the HF-channel bit length. Different modulation schemes may be used for the LF-channel and the HF-channel.

FIG. 5 shows a schematic layout of separation of LF and HF channel bit streams. A combined reading signal 43 contains HF and LF components as explained above with FIG. 4. A separation is performed by a low-pass filtering unit 51 and a high-pass filtering unit 52 for LF and HF channel respectively. The filtered HF data 54 can be threshold detected for detecting the ROM data. The filtered LF data 53 can be threshold detected for detecting the recorded data.

FIG. 6 shows a recorded part of a track having a recordable mirror. The Figure shows a cross-sectional view 61 of recorded ROM disc having pits 64 and lands 65 in a track. The pits and lands are covered with a mirror layer 60 to provide reflection as usual for representing the HF data on optical read only discs like CD. The mirror layer 60 is of a recordable material and accommodates the recorded marks 62,63. Locally, the reflection of the recorded mirror layer varies between relatively low-reflection, e.g. a recorded part 63 indicated by the thin line, and a relatively high-reflection, e.g. an unrecorded part 62 indicated by the heavy line.

For achieving the reflectivity change the recordable ROM disc uses a mirror a material, or stack of materials, having at least two distinct reflection levels. Examples of suitable materials are phase-change layers, alloying metal layers (e.g. Cu/Si, Al/Si), or thin metal layers in which holes are created, etc. The mirror can be switched from reflection-state 1 to reflection-state 2 by applying heat, preferably using an intense focused laser beam (e.g. using the read-laser in high-power mode). The result, after recording, is that the mirror (containing the pits representing HF data) has locally high and low reflection. The recording mechanism may be both low-to-high and high-to-low reflection.

FIG. 7 shows a part of a track having recorded marks by phase differences. The Figure shows a cross-sectional view 71 of recorded ROM disc having pits 74 and lands 75 in a track. The pits and lands represent the HF data and are covered with a recordable layer 70, e.g. a dye applied via spin-coating, to accommodate the recorded marks 72,73. The recorded marks are constituted by phase difference between pits in recorded and unrecorded areas. This may be achieved by applying a recordable dye-layer on top of the reflector containing the pit structure. The refractive index of the unrecorded dye has a different value from the recorded dye (e.g. unrecorded dye n=2.0 and recorded dye n=1.6). Since the spin-coated dye layer fills up the pits (so-called leveling) the phase difference between pit and land in recorded and unrecorded areas of the ROM disc can be adjusted. Locally, the phase difference between the pits and the surrounding land varies due to the different refractive index of the dye in recorded and unrecorded state.

FIG. 8 shows a cross-section of a pit and land sequence filled with dye. The Figure shows a pit 81 and surrounding land 82, the pit-depth 84 being indicated by dₚᵢₜ. A mirror layer 87 covers both pits and lands, and a recordable layer 83, e.g. a dye, is applied on top of the mirror 87. A thin dye layer is present on the land parts, having a thickness t_{land}. Due to the so-called leveling a thick layer of dye is present in the pits, having a thickness tₚᵢₜ. The phase difference between the pits and surrounding land varies due to the different refractive index of the dye in recorded and unrecorded state. The phase difference between light reflected from land-area and light reflected from pit area is approximately (scaled to λ):

φ_{land}=2*t_{land}*n_{dye}

φₚᵢₜ=2*tₚᵢₜ*n_{dye}+2*(t_{land}+dₚᵢₜ−tₚᵢₜ)*n₀

Δφ=2*(tₚᵢₜ−t_{land})*n_{dye}+2*(t_{land}+dₚᵢₜ−tₚᵢₜ)*n₀

Here n₀ is the refractive index of the substrate or cover. The result shows that a change in dye's refractive index is accompanied by a chance in the phase-difference between pit and land and hence in the modulation of the reflected radiation. It is noted that other materials may be used for the recordable layer, for example having a different absorption (usually denoted by k) in recorded and unrecorded state, or showing a combination of a change in n and k.

Although the invention has been mainly explained by embodiments using optical discs based on change of reflection, the invention is also suitable for other record carriers such as rectangular optical cards, magneto-optical discs or any other type of information storage system that has a pre-applied high density read-only pattern optically detectable due to variations of reflected radiation and a recordable layer on top of the read-only pattern for recording low-density recorded marks detectable due to different variations of the reflected radiation. It is noted, that in this document the word ‘comprising’ does not exclude the presence of other elements or steps than those listed and the word ‘a’ or ‘an’ preceding an element does not exclude the presence of a plurality of such elements, that any reference signs do not limit the scope of the claims, that the invention may be implemented by means of both hardware and software, and that several ‘means’ or ‘units’ may be represented by the same item of hardware or software. Further, the scope of the invention is not limited to the embodiments, and the invention lies in each and every novel feature or combination of features described above.

1. Record carrier carrying information represented by read-only marks in a track, the read-only marks (74,75) being optically readable according to a predefined high-density data format via a beam of radiation by first variations of the radiation, the record carrier comprising a recordable layer (70) for writing recorded marks (72,73) in a recording area of the record carrier, which recording area extends over the track (9) carrying the read-only marks, and which recordable layer (70) is arranged to generate second variations of the radiation by a difference between an unrecorded state and a recorded state, the first and second variations being different for allowing detection of the read-only marks and the recorded marks from a same part of the track.

2. Record carrier as claimed in claim 1, wherein the first variations and second variations are variations of intensity of reflected radiation, the second variations being substantially smaller than the first variations.

3. Record carrier as claimed in claim 1, wherein the recorded marks (72,73) are substantially longer than the read-only marks (74,75), in particular an average length the recorded marks being at least ten times an average length of the read-only marks.

4. Record carrier as claimed in claim 1, wherein the recordable layer is a recordable mirror layer (60) having at least two distinct reflection levels for generating the second variations, or a recordable absorption layer having at least two distinct absorption levels for generating the second variations.

5. Record carrier as claimed in claim 1, wherein the recordable layer is a refractive layer (70) having at least two distinct refractive index levels for generating the second variations, in particular the refractive layer substantially filling pits that constitute the read-only marks.

6. Device for recording information on a record carrier carrying information represented by read-only marks in a track, the read-only marks being optically readable according to a predefined high-density data format via a beam of radiation by first variations of the radiation, the record carrier comprising a recordable layer for writing recorded marks in a recording area of the record carrier, which recording area extends over the track carrying the read-only marks, and which recordable layer is arranged to generate second variations of the radiation by a difference between an unrecorded state and a recorded state, the first and second variations being different for allowing detection of the read-only marks and the recorded marks from a same part of the track,
the device comprising
a head (22) for providing the beam, and
recording means (22,27,28,29) for, while scanning the track containing the read-only marks, controlling an intensity of the beam for writing the recorded marks by modifying the recordable layer from the unrecorded state to the recorded state.

7. Device as claimed in claim 6, wherein the device comprises reading means (30) for detecting the read-only marks, and the recording means (22,27,28,29) are arranged for controlling said intensity in dependence of the read-only marks.

8. Device for reading information from a record carrier carrying information represented by read-only marks in a track, the read-only marks being optically readable according to a predefined high-density data format via a beam of radiation by first variations of the radiation, the record carrier comprising a recordable layer for writing recorded marks in a recording area of the record carrier, which recording area extends over the track carrying the read-only marks, and which recordable layer is arranged to generate second variations of the radiation by a difference between an unrecorded state and a recorded state, the first and second variations being different for allowing detection of the read-only marks and the recorded marks from a same part of the track,
the device comprising
a head (22) for providing the beam and generating a reading signal,
reading means (32) for, while scanning the track containing the read-only marks, detecting the second variations for reading the recorded marks.

9. Device as claimed in claim 8, wherein the reading means (32) comprise separation means (34) for simultaneously generating, from the reading signal, a high frequency reading signal for reading the read-only marks and a low frequency reading signal, and for detecting the second variations from the low frequency reading signal for reading the recorded marks.

10. Device as claimed in claim 8, wherein the reading means (32) comprise shift detection means for detecting in the reading signal a shift in amplitude and/or level for detecting the second variations for reading the recorded marks.

11. Device as claimed in claim 8, wherein the device comprise means (30) for detecting the read-only marks, and the reading means (32) are arranged for detecting the second variations in dependence of the read-only marks.

12. Method of recording information on a record carrier carrying information represented by read-only marks in a track, the read-only marks being optically readable according to a predefined high-density data format via a beam of radiation by first variations of the radiation, the record carrier comprising a recordable layer for writing recorded marks in a recording area of the record carrier, which recording area extends over the track carrying the read-only marks, and which recordable layer is arranged to generate second variations of the radiation by a difference between an unrecorded state and a recorded state, the first and second variations being different for allowing detection of the read-only marks and the recorded marks from a same part of the track, the method comprising scanning the track containing the read-only marks via a beam of radiation, and, while scanning the track, controlling an intensity of the beam for writing the recorded marks by modifying the recordable layer from the unrecorded state to the recorded state.
